(19) United States
(12) Patent Application Publication
(10) Pub. No.: US 2017/0361404 A1
(43) Pub. Date: Dec. 21, 2017

(54) DEPOSITION APPARATUS AND DEPOSITION METHOD

(71) Applicant: NATIONAL CHENG KUNG UNIVERSITY, TAINAN CITY (TW)

(72) Inventors: Chi-Chuan HUANG, TAINAN CITY (TW); Chane-Yuan YANG, TAIPEI CITY (TW); Tzu-Hsiang LIN, TAINAN CITY (TW)

(21) Appl. No.: 15/253,901

(22) Filed: Sep. 1, 2016

(30) Foreign Application Priority Data
Jun. 20, 2016 (TW) 105119326

(51) Int. Cl. B23K 26/34; C23C 4/123; B23K 26/146; C23C 6/00; B23K 26/144

(52) U.S. Cl. CPC B23K 26/34; C23C 6/00; B23K 26/144; B23K 26/146; C23C 4/123

(57) ABSTRACT

A deposition apparatus and a deposition method are described. The deposition apparatus includes an accommodating element, a plurality of lasers and a carrier. The accommodating element is configured to accommodate a material. The lasers are disposed at a periphery of the accommodating element, and are configured to simultaneously emit a plurality of laser beams toward the material to melt the material to form a deposition liquid. The carrier is disposed under the accommodating element and the lasers, and are configured to carry the deposition liquid.

### RELATED APPLICATIONS

This application claims priority to Taiwan Application Serial Number 105119326, filed Jun. 20, 2016, which is herein incorporated by reference.

### BACKGROUND

### Field of Invention

The present invention relates to a deposition apparatus and a deposition method. More particularly, the present invention relates to a direct deposition apparatus and a direct deposition method.

### Description of Related Art

A direct metal deposition (DMD) technique is a laser technology, which can be used to manufacture high precise molds and high precise components, and also can be applied to modification, or tool and component repairing. Currently, a common direct metal deposition technique focuses an industrial laser beam on a substrate of a work piece to form a melted bath in the substrate of the work piece, and a metal powder is injected into the melted bath by using nozzles around the industrial laser. During the process, a control system removes the laser beam according to a predetermined geometrical pattern, the laser beam in removing melts the metal particles/powder into liquid metal, and the liquid metal is directly deposited on the substrate of the work piece to form a desired component.

In such a direct metal deposition technique, because the nozzles are the components for delivering the metal particles/powder to the melted bath, the nozzles have a direct effect on a metallurgical property of the deposition layera deposition efficiency, uniformity and accuracy of the deposition process, and brightness and cleanness of a surface of the deposition layer. Therefore, the nozzles are very critical components in the deposition apparatus.

However, the nozzles of the existing deposition apparatus have very low efficiency on depositing and laser melting procedures of the metal particles/powder, and the metal particles/powder are easily deposited by using the nozzles to result in waste of the material. In addition, the current laser direct metal deposition technique typically uses a high power laser, and manufacturing cost of the high power laser is very expensive, thus resulting in high cost of the laser direct deposition processing.

Therefore, a direct deposition apparatus and a direct deposition method, which can effectively decrease spattering of liquid metal and a metal powder, and can reduce waste of the material, and have low cost and high efficiency, are needed in the field.

### SUMMARY

Therefore, one objective of the present invention is to provide a deposition apparatus and a deposition method, which uses various lasers to simultaneously emit various laser beams toward a material supplied by an accommodating element. The deposition material can be applied with various laser beams simultaneously, such that the deposition material can be successfully melted into a deposition liquid without using a high power laser, and the cost of the laser can be greatly decreased, thereby reducing cost of a direct deposition process.

Another objective of the present invention is to provide a deposition apparatus and a deposition method, which can use a metal welding rod to replace metal particles or powder, such that a spatter problem of the metal particles or powder can be solved, thereby increasing utilization of the deposition material, reducing waste of the deposition material, increasing uniformity and accuracy of depositing, and enhancing brightness and cleanness of a surface of a deposition layer.

According to the aforementioned objectives, the present invention provides a deposition apparatus. The deposition apparatus includes an accommodating element, a plurality of lasers, and a carrier. The accommodating element is configured to accommodate a material. The lasers are disposed at a periphery of the accommodating element, and are configured to simultaneously emit a plurality of laser beams toward the material to melt the material into a deposition liquid. The carrier is disposed under the accommodating element and the lasers, and is configured to carry the deposition liquid.

According to one embodiment of the present invention, the material is a welding rod, and the accommodating element is a clamp and is suitable to hold the welding rod.

According to one embodiment of the present invention, the material is a powder, and the accommodating element is a nozzle and is suitable to jet the powder.

According to one embodiment of the present invention, the accommodating element is a movable device, and is suitable to move in relation to the carrier.

According to one embodiment of the present invention, the carrier is a movable device, and is suitable to move in relation to the accommodating element.

According to one embodiment of the present invention, powers of the lasers range from about 30 W to about 1000 W.

According to one embodiment of the present invention, the lasers are equidistantly disposed at the periphery of the accommodating element.

According to one embodiment of the present invention, the deposition apparatus further includes a cover which is configured to cover the accommodating element and the lasers.

According to one embodiment of the present invention, the deposition apparatus further includes a charge-coupled device (CCD) which is disposed on the accommodating element and is configured to monitor the deposition liquid.

According to one embodiment of the present invention, the deposition apparatus further includes at least one gas nozzle, in which a bottom of the accommodating element has a material supplying hole, the at least one gas nozzle is disposed on the bottom of the accommodating element and is located outside the material supplying hole, and the at least one gas nozzle is configured to jet an inert gas to form a gas wall surrounding the material supplying hole.

According to the aforementioned objectives, the present invention further provides a deposition method. In this method, a material is supplied by using a material supplying hole in a bottom of an accommodating element. A plurality of laser beams are emitted toward the material simultaneously under the bottom of the accommodating element to melt the material into a deposition liquid. The deposition liquid is carried by using a carrier.

According to one embodiment of the present invention, the material is a welding rod, the accommodating element is a clamp, and the welding rod is held in the material supplying hole.

According to one embodiment of the present invention, the material is a powder, the accommodating element is a nozzle, and the powder is jetted from the material supplying hole.

According to one embodiment of the present invention, emitting laser beams toward the material simultaneously includes using a plurality of lasers to emit the laser beams, and powers of the lasers range from about 30 W to about 1000 W.

According to one embodiment of the present invention, the lasers are disposed at a periphery of the accommodating element, and are equidistantly disposed at the periphery.

According to one embodiment of the present invention, the deposition method further includes using a cover to cover the accommodating element and the lasers.

According to one embodiment of the present invention, supplying the material includes using at least one nozzle to jet an inert gas to form a gas wall surrounding the material supplying hole.

According to one embodiment of the present invention, carrying the deposition liquid by using the carrier includes moving the carrier in relation to the accommodating element according to a predetermined pattern.

According to one embodiment of the present invention, carrying the deposition liquid by using the carrier includes moving the accommodating element in relation to the carrier according to a predetermined pattern.

According to one embodiment of the present invention, carrying the deposition liquid by using the carrier includes using a charge-coupled device to monitor the deposition liquid.

### BRIEF DESCRIPTION OF THE DRAWINGS

The invention can be more fully understood by reading the following detailed description of the embodiment, with reference made to the accompanying drawings as follows:

FIG. 1 is a schematic drawing of a deposition apparatus in accordance with one embodiment of the present invention;

FIG. 2 is a bottom view showing an accommodating element and lasers of a deposition apparatus in accordance with one embodiment of the present invention; and

FIG. 3 is a flow chart of a deposition method in accordance with one embodiment of the present invention.

### DETAILED DESCRIPTION

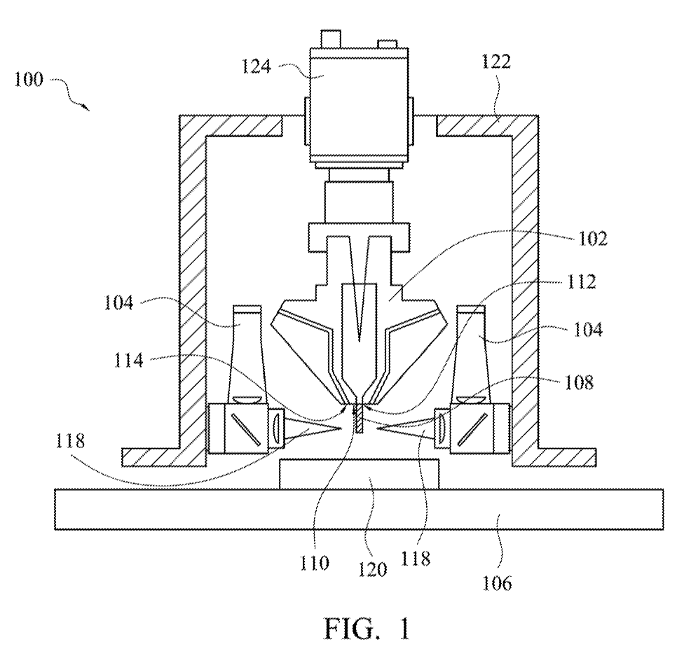

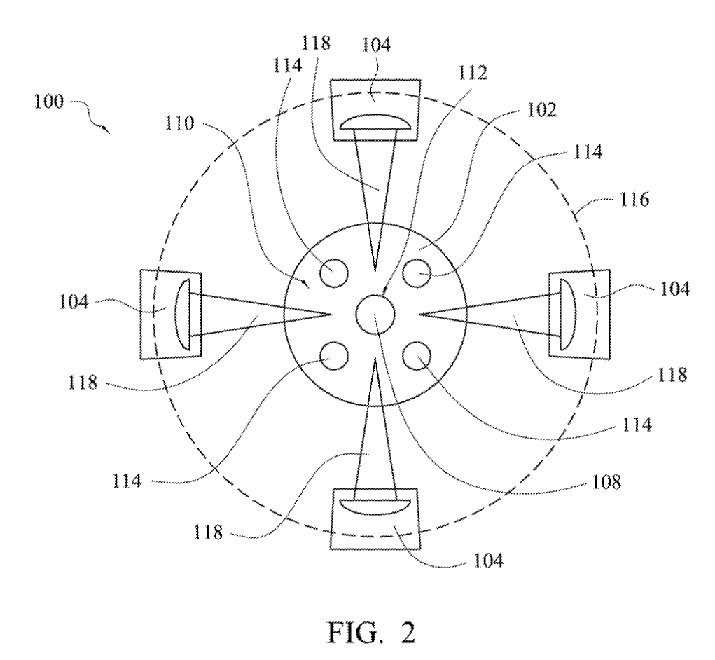

Referring to FIG. 1 and FIG. 2, FIG. 1 is a schematic drawing of a deposition apparatus in accordance with one embodiment of the present invention, and FIG. 2 is a bottom view showing an accommodating element and lasers of a deposition apparatus in accordance with one embodiment of the present invention. In the present embodiment, a deposition apparatus 100 may be a direct deposition apparatus, which can melt a deposition material and directly deposit the melted deposition material onto an object. In some examples, the deposition apparatus 100 may mainly include an accommodating element 102, a plurality of lasers 104 and a carrier 106.

The accommodating element 102 is mainly configured to accommodate and supply a material 108 for depositing. For example, the material 108 may be metal, or a combination of metal and nonmetal. As shown in FIG. 2, a bottom 110 of the accommodating element 102 may have a material supplying hole 112. In some examples, as shown in FIG. 1, the material 108 may be a welding rod, and the accommodating element 102 is a clamp, such that the accommodating element 102 can hold the welding rod in the material supplying hole 112. The welding rod may be, for example, a metal welding rod. When the material 108 is a welding rod, a spatter problem of the powder material can be solved, such that utilization of the material 108 can be increased, waste of the material 108 can be reduced, uniformity and accuracy of the deposition can be enhanced, and brightness and cleanness of a surface of a deposition layer can be increased.

In some examples, as shown in FIG. 2, the deposition apparatus 100 may optionally include one or more gas nozzles 114. In addition, the gas nozzles 114 are disposed on the bottom 110 of the accommodating element 102 and are located outside the material supplying hole 112. For example, the deposition apparatus 100 may include various gas nozzles 114, and the gas nozzles 114 are arranged around the material supplying hole 112. The gas nozzles 114 may be arranged equidistantly, or may be arranged unequidistantly. Sizes of the gas nozzles 114 may be the same, or may be different. In addition, shapes of the gas nozzles 114 may be the same, or may be different. In some certain examples, the deposition apparatus 100 may only include one gas nozzle 114, and the gas nozzle 114 may have a circular shape and surround the material supplying hole 112. The gas nozzles 114 may jet inert gas to form a gas wall surrounding the material supplying hole 112.

Because the gas nozzles 114 are set, in some certain examples, the material 108 may use a powder, the accommodating element 102 is a nozzle, and the accommodating element 102 can jet the powder from the material supplying hole 112 in the bottom 110. For example, the powder may be a metal powder. The gas wall formed by the inert gas jetted from the gas nozzles 114 not only can guide the flow of the jetted material 108 in the form of the powder to prevent the material 108 in the form of the powder from spattering everywhere, but also can guide a dripping direction of a deposition liquid formed by melting the material 108 and cool the deposition liquid. Accordingly, a contamination problem caused by the spattering of the material 108 can be improved, utilization of the material 108 can be increased, accuracy of the deposition process can be enhanced, and the deposition efficiency can be increased.

Referring to FIG. 1 and FIG. 2 again, the lasers 104 are disposed at a periphery 116 of the accommodating element 102, in which the periphery 116 of the accommodating element 102 is represented by a dotted line in FIG. 2. The lasers 104 can simultaneously emit laser beams 118 toward the material 108 supplied from the material supplying hole 112 in the bottom 110 of the accommodating element 102. The laser beams 118 are simultaneously emitted to the material 108, such that the energy of the laser beams 118 heats the material 108 together. Thus, the material 108 can be successfully melted into a deposition liquid by using low power lasers, such as the lasers 104. For example, the powers of the laser 104 may range from about 30 W to about 1000 W. The powers of the lasers 104 may be all the same; portions of the powers of the lasers 104 may be the same, and the other portions of the powers of the lasers 104 may be different; or the powers of the lasers 104 may be different from each other. In some examples, the lasers 104 may be equidistantly disposed at the periphery 116 of the accommodating element 102, such that the material 108 can be heated more uniformly. Of course, in other examples, the lasers 104 may be unequidistantly disposed at the periphery 116 of the accommodating element 102.

With the lasers 104, various laser beams can be emitted to the material 108 simultaneously, such that it is unnecessary to use a high power laser, and thus the cost of the lasers 104 can be greatly reduced, thereby decreasing the cost of the direct deposition process.

As shown in FIG. 1, the carrier 106 is disposed under the accommodating element 102 and the lasers 104, and may carry a deposition liquid which is formed after the material 108 is melted by the laser beams 118 emitted from the lasers 104. The deposition liquid deposited on carrier 106 is solidified to form a deposition object 120 on the carrier 106. The accommodating element 102 and the carrier 106 may move in relation to each other. In some examples, the accommodating element 102 is a movable device, and the carrier 106 is an immovable device, such that the accommodating element 102 can move in relation to the carrier 106. In various examples, the carrier 106 is a movable device, and the accommodating element 102 is an immovable device, such that the carrier 106 can move in relation to the accommodating element 102. In some certain examples, both the accommodating element 102 and the carrier 106 are movable devices, and the accommodating element 102 and the carrier 106 can move in relation to each other according to requirements of the deposition process.

In the present embodiment, the accommodating element 102, the carrier 106, or the accommodating element 102 and the carrier 106 of the deposition apparatus 100 may be connected to a control positioning system, such as a computer numeric control (CNC) system. During the deposition process, the control positioning system removes the accommodating element 102, the carrier 106, or the accommodating element 102 and the carrier 106 according to a structure pattern to be deposited, to adjust the relative position of the accommodating element 102 and the carrier 106, such that the deposition liquid is deposited on the carrier 106 according to the structure pattern.

In some examples, referring to FIG. 1 again, the deposition apparatus 100 may optionally include a cover 122. The cover 122 covers the accommodating element 102 and the lasers 104 to prevent the material 108 or the deposition liquid from spattering, so as to prevent from contaminating or damaging external apparatus, or damaging workers, and to reduce the influence of the external air on the deposition process. In some examples, such as shown in FIG. 1, there is a gap between a lower edge of the cover 122 and the carrier 106 to facilitate the inert gas jetted by the gas nozzles 114 to exhaust out of the cover 122. While the inert gas is exhausted out of the cover 122, an un-melted portion of the material 108, such as the powder, can be carried out of the cover 122.

In some examples, the deposition apparatus 100 may optionally include a monitor device, such as a charge-coupled device 124. As shown in FIG. 1, the charge-coupled device 124 is disposed on the accommodating element 102. During the deposition process, the online workers can use the charge-coupled device 124 to monitor that whether there is something wrong with the deposition process or not. For example, the charge-coupled device 124 may be used to monitor the dripping position of the deposition liquid.

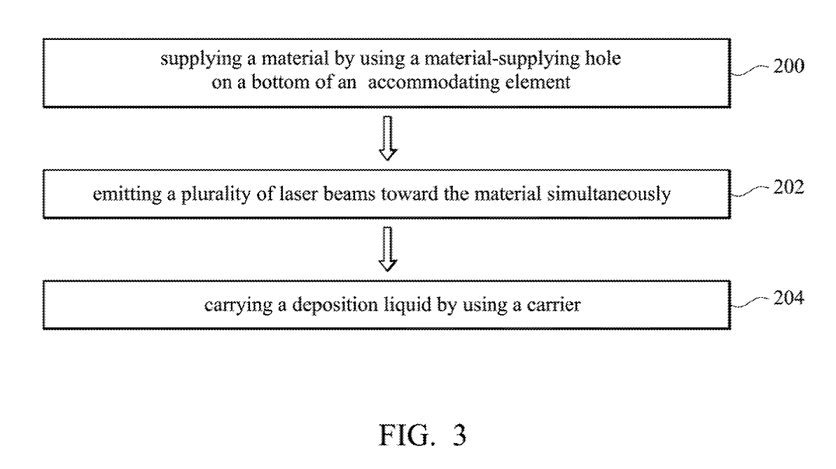

Referring to FIG. 1 through FIG. 3, FIG. 3 is a flow chart of a deposition method in accordance with one embodiment of the present invention. A deposition method of the present embodiment may be a direct deposition method, which may be performed by using the deposition apparatus 100 in the aforementioned embodiment. In some examples, a step 200 may be firstly performed to supply a material 108 by using a material supplying hole 112 in a bottom 110 of an accommodating element 102 of the deposition apparatus 100. In some examples, the material 108 is a welding rod, and the accommodating element 102 is a clamp, such that the accommodating element 102 supplies the material 108 by holding the welding rod in the material supplying hole 112. In some certain examples, the material 108 is a powder, and the accommodating element 102 is a nozzle, such that the accommodating element 102 can jet and supply the powder from the material supplying hole 112 in the bottom 110. In some exemplary examples, in the supplying of the material 108, gas nozzles 114 disposed in the bottom 110 of the accommodating element 102 may be used to jet inert gas, so as to form a gas wall surrounding the material supplying hole 112. In the examples that the material 108 is a powder, the gas wall formed by the inert gas jetted from the gas nozzles 114 can guide the jetted flow of the powder to prevent the material 108 in the form of the powder from spattering everywhere. Thus, the gas nozzles 114 are preferably arranged equidistantly to provide a uniformly-distributed gas flow.

Next, a step 202 may be performed to use the lasers 104 of the deposition apparatus 100 to simultaneously emit laser beams 118 toward the material 108, so as to simultaneously use the laser beams 118 to melt the material 108 into a deposition liquid while the material 108 is supplied. The method emits various laser beams 118 toward the material 108 simultaneously, and the energy of the laser beams 118 heats the material 108 together, such that the material 108 can be successfully melted into a deposition liquid by using low power lasers as the lasers 104. Thus, it is unnecessary to use a high power laser in the method. In some exemplary examples, the powers of the laser 104 may range from about 30 W to about 1000 W. As shown in FIG. 2, the lasers 104 may be preferably disposed at the periphery 116 of the accommodating element 102 equidistantly, such that the material 108 can be heated more uniformly. Of course, in other examples, the lasers 104 may be unequidistantly disposed at the periphery 116 of the accommodating element 102.

Then, a step 204 may be performed to use a carrier 106 of the deposition apparatus 100 to carry the melted and dripping deposition liquid. The deposition liquid is solidified to form a deposition object 120 on the carrier 106. In the deposition apparatus 100, the accommodating element 102 and the carrier 106 may move in relation to each other. In addition, the accommodating element 102, the carrier 106, or the accommodating element 102 and the carrier 106 of the deposition apparatus 100 may be connected to a control positioning system, such as a computer numeric control system. In some examples, the accommodating element 102 is a movable device, and the carrier 106 is an immovable device, such that when the carrier 106 is used to carry the deposition liquid, the accommodating element 102 can be removed in relation to the carrier 106 by using the control positioning system according to a predetermined pattern, so as to deposit the deposition liquid on the carrier 106 according to the predetermined pattern. In some examples, the carrier 106 is a movable device, and the accommodating element 102 is an immovable device, such that when the carrier 106 is used to carry the deposition liquid, the carrier 106 can be removed in relation to the accommodating element 102 by using the control positioning system according to a predetermined pattern. In some examples, both the accommodating element 102 and the carrier 106 are movable devices, and when the carrier 106 is used to carry the deposition liquid, the accommodating element 102 and/or the carrier 106 can be removed by using the control positioning system according to a predetermined pattern.

In some exemplary examples, when the carrier 106 is used to carry the deposition liquid, a charge-coupled device 124 of the deposition apparatus 100 may be optionally used to monitor that whether there is something wrong with the deposition liquid during the deposition process or not. For example, the charge-coupled device 124 may be used to monitor the dripping position of the deposition liquid.

In the present embodiment, when the deposition apparatus 100 is used to perform the deposition process, a cover 122 may be optionally used to cover the accommodating element 102 and the lasers 104 to prevent the material 108 or the deposition liquid from spattering, so as to prevent from contaminating or damaging external apparatus, or damaging workers, and to reduce the influence of the external air on the deposition process. In some examples, such as shown in FIG. 1, there is a gap between a lower edge of the cover 122 and the carrier 106, such that the inert gas jetted by the gas nozzles 114 can be exhausted out of the cover 122 through the gap between the cover 122 and the carrier 106. While the inert gas is exhausted out of the cover 122, an un-melted portion of the material 108 can be carried out of the cover 122.

According to the aforementioned embodiments, one advantage of the present invention is that a deposition apparatus and a deposition method of the present invention use various lasers to simultaneously emit various laser beams toward a material supplied by an accommodating element. The deposition material can be applied with various laser beams simultaneously, such that the deposition material can be successfully melted into a deposition liquid without using a high power laser, and the cost of the laser can be greatly decreased, thereby reducing the cost of a direct deposition process.

According to the aforementioned embodiments, another advantage of the present invention is that a deposition apparatus and a deposition method of the present invention can use a metal welding rod to replace metal particles or powder, such that a spatter problem of the metal particles or powder can be solved, thereby increasing utilization of the deposition material, reducing waste of the deposition material, increasing uniformity and accuracy of depositing, and enhancing brightness and cleanness of a surface of a deposition layer.

Although the present invention has been described in considerable detail with reference to certain embodiments thereof, the foregoing embodiments of the present invention are illustrative of the present invention rather than limiting of the present invention. It will be apparent to those having ordinary skill in the art that various modifications and variations can be made to the present invention without departing from the scope or spirit of the invention. Therefore, the spirit and scope of the appended claims should not be limited to the description of the embodiments contained herein.

What is claimed is:

1. A deposition apparatus comprising:
an accommodating element configured to accommodate a material;
a plurality of lasers disposed at a periphery of the accommodating element, and configured to simultaneously emit a plurality of laser beams toward the material to melt the material into a deposition liquid; and
a carrier disposed under the accommodating element and the lasers, and configured to carry the deposition liquid.

2. The deposition apparatus of claim 1, wherein
the material is a welding rod; and
the accommodating element is a clamp, and is suitable to hold the welding rod.

3. The deposition apparatus of claim 1, wherein
the material is a powder; and
the accommodating element is a nozzle, and is suitable to jet the powder.

4. The deposition apparatus of claim 1, wherein the accommodating element is a movable device, and is suitable to move in relation to the carrier.

5. The deposition apparatus of claim 1, wherein the carrier is a movable device, and is suitable to move in relation to the accommodating element.

6. The deposition apparatus of claim 1, wherein powers of the lasers range from 30 W to 1000 W.

7. The deposition apparatus of claim 1, wherein the lasers are equidistantly disposed at the periphery of the accommodating element.

8. The deposition apparatus of claim 1, further comprising a cover which is configured to cover the accommodating element and the lasers.

9. The deposition apparatus of claim 1, further comprising a charge-coupled device disposed on the accommodating element and configured to monitor the deposition liquid.

10. The deposition apparatus of claim 1, further comprising at least one gas nozzle, wherein a bottom of the accommodating element has a material supplying hole, the at least one gas nozzle is disposed on the bottom of the accommodating element and is located outside the material supplying hole, and the at least one gas nozzle is configured to jet an inert gas to form a gas wall surrounding the material supplying hole.

11. A deposition method comprising:
supplying a material by using a material supplying hole in a bottom of an accommodating element;
emitting a plurality of laser beams toward the material simultaneously under the bottom of the accommodating element to melt the material into a deposition liquid; and
carrying the deposition liquid by using a carrier.

12. The deposition method of claim 11, wherein the material is a welding rod, the accommodating element is a clamp, and the welding rod is held in the material supplying hole.

13. The deposition method of claim 11, wherein the material is a powder, and the accommodating element is a nozzle, and the powder is jetted from the material supplying hole.

14. The deposition method of claim 11, wherein emitting laser beams toward the material simultaneously comprises using a plurality of lasers to emit the laser beams, and powers of the lasers range from 30 W to 1000 W.

15. The deposition method of claim 14, wherein the lasers are disposed at a periphery of the accommodating element, and are equidistantly disposed at the periphery.

16. The deposition method of claim 14, further comprising using a cover to cover the accommodating element and the lasers.

17. The deposition method of claim 11, wherein supplying the material comprises using at least one nozzle to jet an inert gas to form a gas wall surrounding the material supplying hole.

18. The deposition method of claim 11, wherein carrying the deposition liquid by using the carrier comprises moving the carrier in relation to the accommodating element according to a predetermined pattern.

19. The deposition method of claim 11, wherein carrying the deposition liquid by using the carrier comprises moving the accommodating element in relation to the carrier according to a predetermined pattern.

20. The deposition method of claim 11, wherein carrying the deposition liquid by using the carrier comprises using a charge-coupled device to monitor the deposition liquid.
